(19) United States
(12) Patent Application Publication
(10) Pub. No.: US 2017/0264149 A1
(43) Pub. Date: Sep. 14, 2017

(54) MOTOR FOR A SUCTION ASSEMBLY OF AN ENHANCED-PERFORMANCE EXTRACTOR HOOD

(71) Applicant: Faber S.p.A., Fabriano (Ancona) (IT)

(72) Inventor: Ivo Marra, Castelfidardo (Ancona) (IT)

(73) Assignee: Faber S.p.A., Fabriano (Ancona) (IT)

(21) Appl. No.: 15/511,398

(22) PCT Filed: Sep. 15, 2015
(86) PCT No.: PCT/IB2015/057076

§ 371 Date: Mar. 15, 2017

(30) Foreign Application Priority Data
Sep. 15, 2014 (IT) MI2014A001590

(51) Int. Cl. H02K 1/16; H02K 1/18; F24C 15/20; H02K 17/04

(52) U.S. Cl. CPC H02K 1/165; H02K 17/04; H02K 1/185; F24C 15/2042; H02K 2213/03

(57) ABSTRACT

A single-phase asynchronous motor (1) for a suction assembly of an extractor hood (5) comprises a stator (13) wherein a rotor is driven into rotation, a driving shaft (15) carrying a rotor (16) being integral with the latter for sucking smokes and vapors from a cooktop placed below the hood (5) and for sending them towards an output (8) of the hood, said stator (13) comprising a plurality of stator core laminations (22) provided with sixteen slots (30) containing metal electrical windings wherein current flows so as to generate a magnetic flux suitable for causing the rotation of the rotor. The stator has an outer diameter (D2) greater than 80 mm, the number of the slots (30) being sixteen, such slots having a unit surface of at least 70 mm².

### BACKGROUND

The object of the present invention is a single-phase asynchronous motor for a suction assembly of an extractor hood.

It is known that an extractor hood of the type used in kitchens, for instance above a cooktop, comprises a structure provided with a first aperture at a first end thereof located, in this example, above the cooktop (or close thereto if the suction device is placed inside the piece of furniture that supports such cooktop) and with an internal duct opening in correspondence with a second aperture of said structure.

Within such structure, in said duct there is placed a suction assembly equipped with a fan including a rotor driven by an electric motor and suitable for sucking from the cooktop smokes and vapors that generate thereon during the preparation of foods and for transferring such smokes and vapors towards the second aperture of said structure.

The latter is, for instance, connected, either directly or indirectly, to an exhaust of such smokes and vapors towards the outside of the house which the kitchen is part of or opens directly into such environment.

With a special reference to the electric motors used in Venturis for extractor hoods or devices of the mentioned type, they can be of the brushless motor type with a specific control circuit, a solution that has greater complexities (bound for instance to such circuit) and costs (of use, control, and mounting) than solutions wherein the motor is a shaded pole motor or is a single-phase asynchronous motor with a capacitor. The present invention addresses this latter type of motors.

The latter motors are widely used in extractor hoods where they support and move a rotor fixed to and overhanging from the motor on its (output) shaft.

It is just because such motors are inserted in fans that they have to be in turn located in extractor hoods often having reduced dimensions (for instance, corresponding to those of a suspended wall cupboard of a kitchen or such as to allow the presence of a suspended wall cupboard above the hood), said motors shall have definite overall dimensions equal to 106 mm (the height of the motor, calculated along the motor shaft) by 100 mm (the length of the motor).

In addition, still for the reasons explained before bound to their use, the electric motors used in extractor hoods shall have a mass (and consequently a weight) that is as low as possible in order for them to be correctly supported by the fan's structure. As a matter of fact, the axis or shaft of the motor is aligned with the axis of the rotor and is integral, along with it, with said structure. Increasing the weight of the motor beyond a given limit results in problems of structural strength, thus causing the fixing system to break, for instance during fall tests.

In addition to the limitations in terms of mass and dimensions shown by the known electric motors, these also have substantial power consumptions and/or reduced efficiencies, which results in energy efficiency classes relatively high for the extractor hoods on which they are assembled.

Moreover, such motors are relatively noisy because of the way how any change in their speed of rotation is performed: usually this is obtained by modifying the waveform of the current that is fed thereto, which implies vibrations of the stator pack, of the windings, and consequently of the motor as a whole.

These vibrations are also determined by the imperfect concentricity between the outer diameter of the rotor and the inner diameter of the stator, said concentricity being determined by the correct positioning of usual stator caps with respect to the outer diameter of the stator.

U.S. Pat. No. 5,163,869 describes a method and an apparatus for ventilating gases containing condensable vapors generating in a room, for instance a kitchen. In particular such prior document relates to a ventilation device suitable for preventing the building-up of grease, oil, solvent, or another content in such gases within said apparatus. The previous patent describes the use of an induction electric motor having a stator and a rotor which an impeller of the fan of such apparatus is integral with via the output shaft.

This prior document nothing says about the construction of the motor nor of its components, nor about the dimensions thereof. From such previous text only the use of electric motors in an extractor hood or device for kitchens is appreciated. Nothing is described in the prior document about the dimensional and/or weight problems of the electric motors for hoods nor about the problems relating to vibrations as described above.

U.S. Pat. No. 3,942,055 relates to a stator for an electric machine with such number of poles and dimensions as not to be capable of meeting the dimensional and weight limitations specified above for the motors of fans of extractor devices for kitchens. Furthermore, this previous patent does not describe nor suggest to limit the number of stator slots down to such an optimum value as to get a maximum fan efficiency, while having reduced motor dimensions.

U.S. Pat. No. 3,589,266 describes an extractor hood with a fan equipped with an electric motor of its own. This anteriority does not face the dimensional and/or mass problems of the motor which might limit its application in such hood, nor does it describes how the motor is constructed.

### SUMMARY

A purpose of the present invention is to offer a single-phase asynchronous motor for a suction assembly of an extractor hood that overcomes the drawbacks of the already known similar motors.

In particular, a purpose of the present invention is to provide an electric motor of the mentioned type for a fan of a suction assembly that allows to obtain a constructional and technical trade-off between mass of the motor, quality of the construction materials, and electromechanical features thereof whereby it is not possible, beyond a certain point, to reduce the overall dimensions and/or the weight while trying to warranty the same performances of the fan. In other words, a purpose of the invention is to provide an electric motor that, if coupled with a rotor or impeller and volute system of a fan, warranties the best result in terms of fan efficiency, a result which is given by the product between motor efficiency and fluid dynamics efficiency. Since the latter is specific to every rotor and volute combination, this one being equal, the greater is the efficiency of the motor, the greater is the efficiency of the fan.

Another purpose is to offer an electric motor suitable for providing the maximum efficiency of the fan, compliance with the flow-rate performance (for instance 800 [m³/h] at 0 [Pa]) and static pressure (for instance about 500 [Pa] at 0 [m³/h)]) requested by the market.

Another purpose of the invention is to offer a motor of the mentioned type that has an efficiency greater than that of the known solutions and that makes it possible for the hood where it is inserted to be classified to a high energy efficiency class without the use of brushless motors, which are more expensive from both the constructional and control points of view.

Another purpose is to offer a motor of the mentioned type that has optimized power consumptions, reduced dimensions, and a use of the windings improved with respect to the known solutions.

Another purpose is to offer a motor of the mentioned type that can be controlled via inexpensive and simpler control systems.

Another purpose is to offer a motor of the mentioned type that can be fixed to the structure of the hood in such a way that the mounting elements suitable for obtaining such fixing don't interfere with the magnetic field generated by the windings of the stator.

Another purpose is to offer a motor of the mentioned type that is subjected to less heating during its use.

These purposes and others which will be apparent to those skilled in this sector are achieved by an asynchronous motor according to the attached claims.

### BRIEF DESCRIPTION OF THE DRAWINGS

For a better understanding of the present invention the following drawings are attached for merely explanatory, not limitative, purposes, wherein:

FIG. 1 transparently shows an extractor hood provided with a motor according to the invention;

FIG. 2 shows a side view of a motor according to the invention;

FIG. 3 shows a front view of the stator of the motor in FIG. 2, the rotor being omitted; and

FIGS. 4-6 show comparative diagrams relevant to the noise generated by the motor according to the invention operating at different speeds V1,V2, and V3 as compared with a similar motor according to the present status of the art.

### DETAILED DESCRIPTION OF THE PREFERRED EMBODIMENTS

With reference to the mentioned figures, a single-phase asynchronous motor 1 according to the invention for a fan of a suction assembly is inserted within a cavity 2 of a duct 3 of a structure 4 of an extractor hood 5 suitable for being installed above a cooktop of a kitchen (not shown). Such duct 3 comprises a first aperture 7 at a first end thereof located above such cooktop and a second aperture 8 at a second end thereof which operates as an exhaust of whatever is sucked (smokes and vapors, said suction being shown by arrow F) from the cooktop towards the outside of the kitchen or in the kitchen itself. In the former case, such second aperture 8 is connected to a duct, not shown.

On the first aperture 7 there are located filtering means 10 known by themselves.

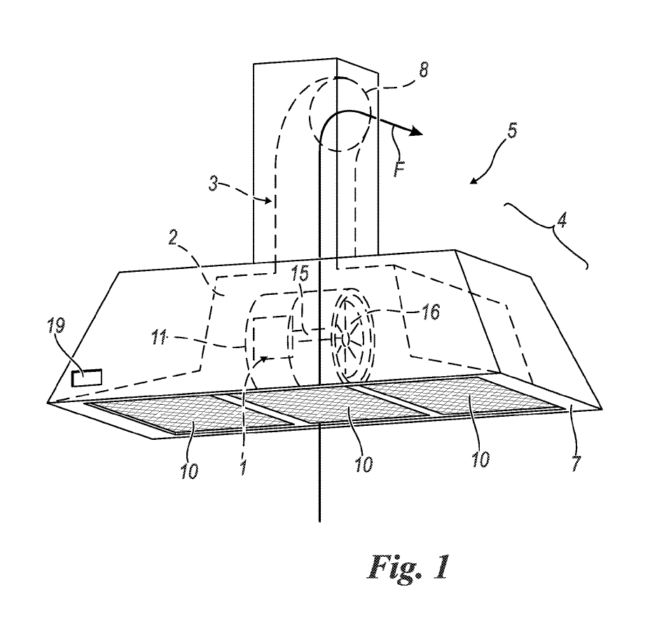

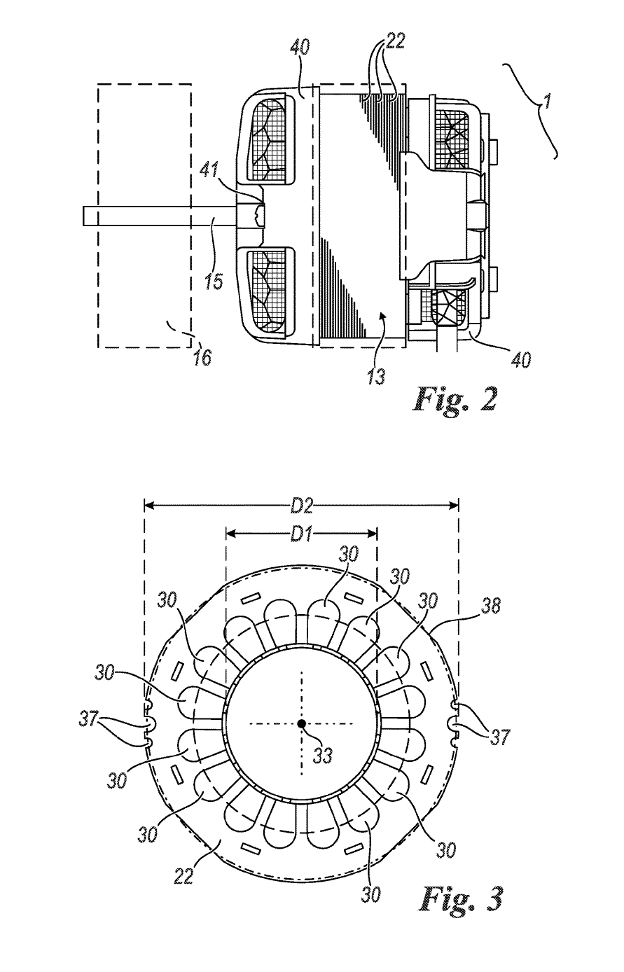

The motor 1 is inserted in and fixed to, in the example shown in FIG. 1, a container 11 of the fan which is in turn constrained, in a manner known by itself, to the structure 4 mentioned above; the motor 1 can also be directly fixed to the latter. Such motor comprises a stator 13 and a rotor internal thereto, with which there is associated an output shaft 15 on which a rotor 16 of the fan is keyed in a manner known by itself suitable for sucking the smokes and vapors mentioned above. The motor and consequently the fan are driven and controlled by a usual drive and control circuit, not shown, subjected to a control generated by a user operating on a control interface 19 (shown in FIG. 1 for explanatory purposes).

The motor according to the invention comprises a stator having an inner diameter D1 (>40 [mm]) similar to that of the known motors, but an outer diameter D2 greater than that of the latter (usually <80 [mm]). Specifically, the diameter D2 is greater than 80 mm and is preferably less than 87 mm.

In the stator core laminations 22 of such stator 13 sixteen (16) slots are present.

Thanks to their greater width, the slots can contain a higher number of windings or cables of a greater cross-section; this allows to have a higher efficiency of the motor due to the reduced losses by Joule effect, the height of the bundle of stator core laminations being equal to that of the known motors, which entails the possibility of bringing the energy efficiency class of the hood to a level higher than those which use known motors. This applies, the height of the pack of stator core laminations and of the fluid dynamics system in which the motor is installed being equal. This allows to optimize the efficiency of the fan of the hood while limiting the dimensions and the weight of its motor.

Furthermore, there is an optimization in the power consumption of the motor because electrical efficiency increases; one might devise to reduce the height of the stator pack hence of the motor in general, in order to equal the efficiency of the new motor to that of a motor currently in use, to the advantage of the possibility of using the motor in hoods featuring particularly reduced dimensions.

All of this allows to meet the most stringent standards bound to the energy efficiency class of the hood, which is impossible or very difficult to obtain with the known motors because of the impossibility of increasing the dimensions in height beyond a certain value (for its positioning in the structure 4) and above all of increasing the number of the windings in the slots and their cross section and of their stators because of the current dimensions of the slots themselves.

The stator core laminations 22 comprise apertures or peripheral seats 37 suitable for accommodating (partially, because they open on the perimetral edge 38 of every stator core lamination) screws to fix the stator pack within the stator's body. This means that such screws (not shown) do not cross the stator pack internally thereto (i.e. within every stator core lamination 22, far away from the edge 38), as in the known solutions. This allows to prevent interferences of such screws with the magnetic field generated by the stator to the full advantage of the efficiency of the latter.

Also, such screws do not interfere with the windings, because the usual caps 40 of the stator comprise seats 41 for the screws themselves outside the diameter of the stator. It is to be noted that the greater transversal dimension of the stator, the new position of the screws, and the perfect concentricity between the rotor assembly and the stator assembly, lead to a reduced noise generated by the motor according to the invention as referred to the known solutions.

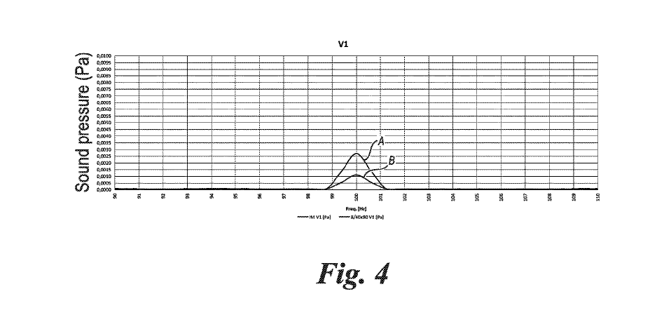

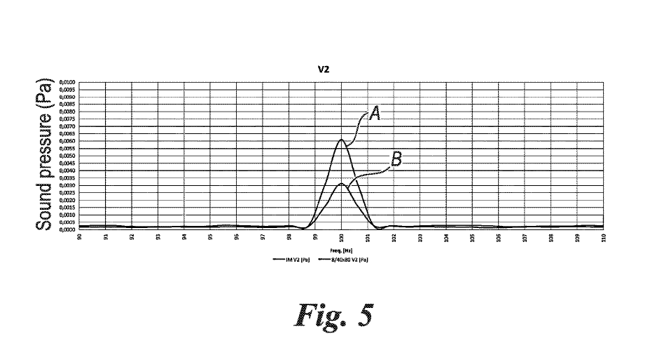

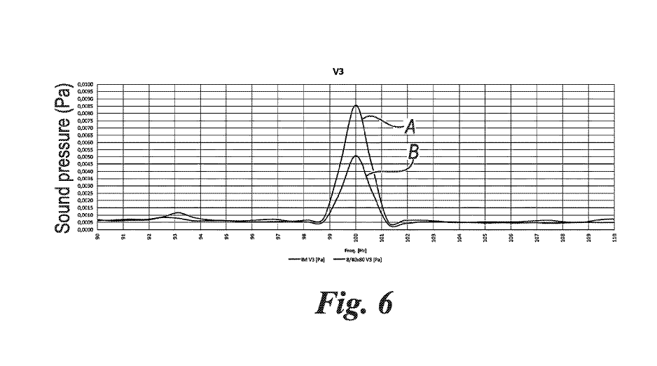

As a matter of fact, the diagrams in FIGS. 4-6 show substantial reductions of the sound pressure (in the ordinate) with respect to the frequency of rotation measured at different speeds of rotation V1, V2, V3: curve A shows the noise of the known motors (the motor, diffuser, rotor fluid dynamics system being equal), whereas curve B shows the noise generated by the motor according to the invention. A reduction of the peak of sound pressure (or noise) of curve B with respect to curve A is apparent.

Thanks to the invention, it is possible to obtain a motor 1 for a fan of an extractor hood having a higher efficiency with respect to its corresponding known motors, the height of pack of stator core laminations being equal, which allows for the hood 5 wherein it is placed to be classified to a high energy efficiency class (for instance class A according to the European standards). Furthermore, the motor 1 is more compact with respect to the known ones, the power being equal, vibrates less than the latter, is not too heavy, and cools better than the known motors thanks to the increased transversal dimensions of the laminations with respect to the dimensions of the known motors, the power being equal (every lamination featuring a diameter greater than 80 mm and lower than 87 mm versus a maximum diameter of 80 mm of the laminations of such known motors).

Others embodiments of the invention can be obtained in the light of the previous description and are to be considered to fall within the scope of the following claims

1. A single-phase asynchronous motor (1) for a suction assembly of an extractor hood (5), said motor comprising a stator (13) and a rotor that is driven into rotation, a driving shaft (15) carrying the rotor (16) that is integral therewith, the rotor being adapted to suction smoke and vapors from a cooktop placed below the hood (5) and for their delivery towards an output (8) of the hood, said stator (13) comprising a plurality of stator core laminations (22) provided with slots (30) containing electrical windings through which current flows so as to generate a magnetic flux suitable for causing the rotation of the rotor, the stator has an outer diameter (D2) greater than 80 mm, the slots (30) are sixteen in number and have at least 70 mm² of unit surface.

2. A motor according to claim 1, wherein in correspondence with a perimetral edge (38) thereof, each said stator core lamination (22) presents seats (37) suitable for accommodating screws for fixing said stator core laminations and for allowing the mounting of the stator with caps (40).

3. The motor according to claim 2, wherein such said seats (37) open on the peripheral edge (38) of each said stator core lamination.

4. The motor according to claim 1, wherein the stator (13) has an inner diameter (D1) equal to or greater than 40 mm.
